(19) United States
(12) Patent Application Publication
(10) Pub. No.: US 2004/0205494 A1
(43) Pub. Date: Oct. 14, 2004

(54) Discussion board of a website having images

(75) Inventors: Matthew H. Bernius, Rochester, NY (US); Thomas J. Hoehn, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/966,314

(22) Filed: Sep. 28, 2001

(51) Int. Cl. G06F 17/21

(52) U.S. Cl. 715/501.1; 715/530

(57) ABSTRACT

A discussion board of a website having images associated with a portion of the text, the discussion board comprises a discussion portion having text inserted by users of the discussion board; a text-insert section which inserts written text into the discussion portion for discussing one or more subjects; and a webpage which automatically inserts either a predetermined image or an uploaded image into the discussion portion upon command for enhancing the text upon request.

### FIELD OF THE INVENTION

The invention relates generally to the field of discussion boards for the Internet and, more particularly, to such discussion boards having images for providing enhanced discussion.

### BACKGROUND OF THE INVENTION

As is well known, various websites have discussion boards in which users insert comments and the like that are viewable by subsequent users of the discussion. Typically, the Internet nickname of the user appears next to the text inserted by that particular user.

Although the presently known and utilized discussion boards are satisfactory, they include drawbacks. It has been said that a picture speaks a thousand words. In this regard, most current discussion boards do permit inclusion of pictures or images, and the remaining discussion boards that do permit inclusion of images require that the user know HTML programming or the like. This process and viewing experience is cumbersome and inefficient.

Consequently, a need exists for a seamless, easy application to allow end users to add images to discussion boards.

### SUMMARY OF THE INVENTION

The present invention is directed to overcoming one or more of the problems set forth above. Briefly summarized, according to one aspect of the present invention, the invention resides in a discussion board of a website having images associated with a portion of the text, the discussion board comprising (a) a discussion portion having text inserted by users of the discussion board; (b) a text-insert section which inserts written text into the discussion portion for discussing one or more subjects; and (c) a webpage which automatically inserts either a predetermined image or an uploaded image into the discussion portion for enhancing the text upon request.

These and other aspects, objects, features and advantages of the present invention will be more clearly understood and appreciated from a review of the following detailed description of the preferred embodiments and appended claims, and by reference to the accompanying drawings.

Advantageous Effect Of The Invention

The present invention has the advantage of including images on discussion board in a uniform and user-friendly fashion, which images are also viewable in a higher resolution version.

### BRIEF DESCRIPTION OF THE DRAWINGS

FIG. 1 is an illustration of a typical webpage having a discussion board;

FIG. 2 is an illustration of a second webpage associated with the discussion board for inserting images into the discussion board; and

FIG. 3 is an illustration of the discussion board having a pop-up window containing a high resolution version of the image.

### DETAILED DESCRIPTION OF THE INVENTION

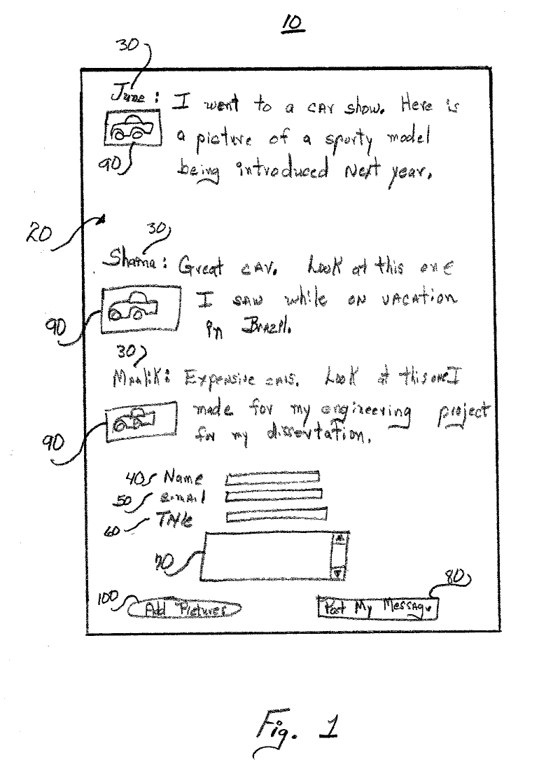

Referring to FIG. 1, there is shown a webpage 10 of the website having the discussion board 20. The discussion board 20 includes a user name 30 associated with the particular user. The user, from their remote computer terminal, views the discussion board and inputs descriptive information, such as their name, e-mail address, title for their comments, and their particular comments into the appropriate fields (name 40, e-mail address 40, title 60 and comment section 70), all of which is then transmitted over the Internet. The website receives the information and respectively inserts it into the name section 40, e-mail address section 50, title section 60 and text section 70 as directed by the user. A “Post My Message” icon 80 is also disposed at the lower portion of the discussion board for posting the input information into the discussion board 20 without images. It facilitates understanding that the above is implemented via software all of which is widely used and available, and consequently, the details of the software need not be described in detail herein.

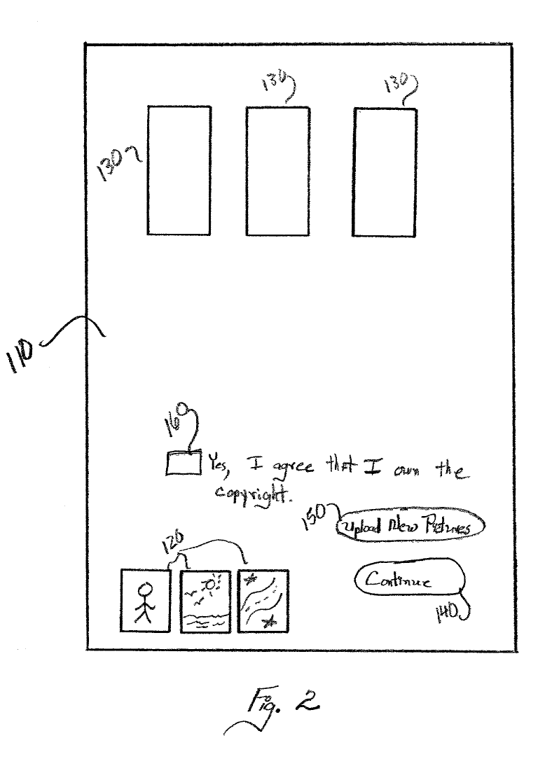

If images 90 are also to be included, the user delays initialing the posting icon 80 until the images are received. In this regard, a hyperlink 100 in the form of a graphical icon (for example, “add pictures”) is located at a lower portion of the webpage. The user activates it, such as by clicking thereon, which directs the website to display the second webpage 110. Referring to FIG. 2, there is shown the second webpage 110. The second webpage 110 includes a plurality of pre-selected images 120 uploaded earlier by the user, three in the preferred embodiment, which are available for selection as an image to be associated with the particular comments. The user selects either one, two or all of the images 120, by clicking the selected image or images, into one of the selection boxes 130 for indicating the image or images as their image content for their comments. The user then selects the continue icon 140. The user is taken back to the first webpage 20 and the posting icon 80 is selected, and the images and the previously input name, title and comments are then inserted into the discussion board after the last previous comments.

Images may also be uploaded by clicking the “upload new pictures” icon 150 which causes the website to interact with the user's computer workstation to upload additional images for selection as the user's images for input with their text. These images are inserted into one of the selection boxes 130. The user is prompted to indicate copyright ownership in the copyright box 160 before the images will be further processed for prohibiting unauthorized images for display. After upload, the user selects the continue button 140. Likewise, the user is taken back to the first webpage 20 where the user selects the posting icon 80 for posting the images and the previously inputted name, title and comments into the discussion board 20.

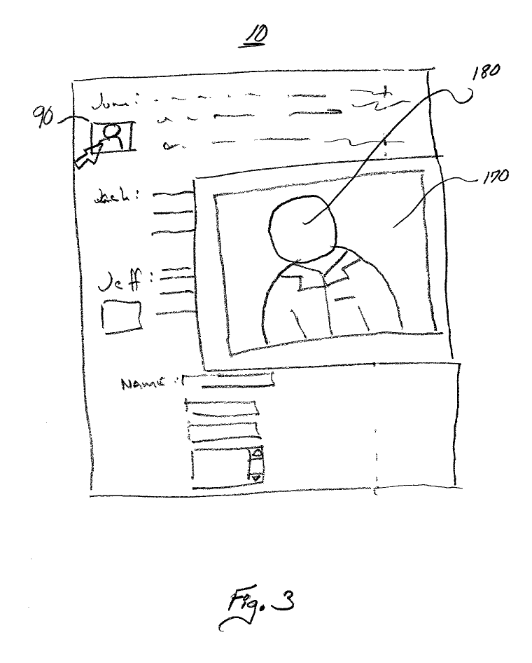

Referring to FIG. 3, the present invention creates a low resolution image 90 or thumbnail for each selected image and includes it with the user's name, title and comments into the discussion board. By clicking on the lower resolution version 90, a new window 170 (occupying a portion of the screen) is opened containing a high resolution version 180 of the image. The high resolution image 180 is closed by clicking on the high resolution image.

The above-described paragraph is implemented via software, which is available for licensing, by Eastman Kodak Company, or may be written by those skilled in the art from the above description. Therefore, the details of the software will not be described herein.

The invention has been described in detail with particular reference to certain preferred embodiments thereof, but it will be understood that variations and modifications can be effected within the spirit and scope of the invention.

### Parts List

10 website

20 discussion board

30 names

40 name

50 e-mail address

60 title

70 comment box

80 icon

90 images or pictures

100 icon

110 second webpage

120 images

130 selection boxes

140 icon

150 icon

160 copyright box

170 pop-up window

180 high resolution image

What is claimed is:

1. A discussion board of a website having images associated with a portion of the text, the discussion board comprising:
(a) a discussion portion having text inserted by users of the discussion board;
(b) a text-insert section which inserts written text into the discussion portion for discussing one or more subjects; and
(c) a webpage which automatically inserts either a predetermined image or an uploaded image into the discussion portion upon command for enhancing the text upon request.

2. The discussion board as in claim 1 further comprising a link to the webpage.

3. The discussion board as in claim 1, wherein the webpage includes a plurality of pre-determined images for selection.

4. The discussion board as in claim 1, wherein the webpage includes verification of copyright ownership.

5. A method for using a discussion board, the method comprising the steps of:
(a) retrieving the discussion board from the Internet;
(b) inserting text into a discussion portion of the discussion board for discussing one or more subjects; and
(c) automatically inserting images into the discussion board upon command for providing enhancement to the text.

6. The method as in claim 5 further comprising activating a link to a webpage which uploads an image for insertion into the discussion board, or contains pre-determined images for insertion into the discussion board.

7. The method as in claim 5 further comprising selecting at least one image from a plurality of pre-determined images for insertion into the discussion board.

8. The method as in claim 5 further comprising verifying copyright ownership of downloaded images.

9. A discussion board of a website having images associated with a portion of the text, the discussion board comprising:
(a) a first set of text input on-line on a substantially real-time basis having image, if any, positioned adjacent the first text; and
(b) a second set of text input on-line on a substantially real-time basis having a corresponding image, if any, positioned adjacent the second text.
